(19) United States
(12) Patent Application Publication
(10) Pub. No.: US 2022/0197501 A1
(43) Pub. Date: Jun. 23, 2022

(54) INFORMATION PROCESSING APPARATUS AND NON-TRANSITORY COMPUTER READABLE MEDIUM STORING INFORMATION PROCESSING PROGRAM

(71) Applicant: FUJIFILM Business Innovation Corp., Tokyo (JP)

(72) Inventor: Shota KIRIKAWA, Kanagawa (JP)

(73) Assignee: FUJIFILM Business Innovation Corp., Tokyo (JP)

(21) Appl. No.: 17/335,102

(22) Filed: Jun. 1, 2021

(30) Foreign Application Priority Data
Dec. 22, 2020 (JP) 2020-212717

(51) Int. Cl. G06F 3/0488; G06F 3/0481; G06F 3/0486

(52) U.S. Cl. CPC G06F 3/04886; G06F 3/0486; G06F 3/04817

(57) ABSTRACT

An information processing apparatus includes a processor configured to display an area divided by disclosure range of data on a screen, execute at least one of processing of displaying the area in a different display mode by disclosure range or processing of changing a display mode of an image representing the data depending on a display position of the image on the screen, and in a case where the image is disposed in the area, disclose the data to a disclosure destination included in the disclosure range corresponding to the area.

### CROSS-REFERENCE TO RELATED APPLICATIONS

This application is based on and claims priority under 35 USC 119 from Japanese Patent Application No. 2020-212717 filed Dec. 22, 2020.

### BACKGROUND

### (i) Technical Field

A technique of the invention relates to an information processing apparatus and a non-transitory computer readable medium storing an information processing program.

### (ii) Related Art

JP2015-141475A discloses an information processing apparatus including a touch panel having a display unit that displays an icon in a display area, and an input unit that receives a touch operation of a user. The information processing apparatus includes an icon position determination unit that determines whether or not a display position of the icon in the display area is within an end portion vicinity area that is the vicinity of at least any end portion in a case where the touch operation is an operation to the icon. The information processing apparatus includes an operation position determination unit that determines whether or not a position of the touch operation to the icon is within an operation invalidation area in the vicinity of the end portion vicinity area including the icon in a case where the icon position determination unit determines that the display position is within the end portion vicinity area. The information processing apparatus includes an execution unit that executes processing associated with the icon in a case where determination is made that the position of the touch operation is not within the operation invalidation area, and not executing the processing in a case where determination is made that the position of the touch operation is within the operation invalidation area.

JP1997-190287A discloses an information processing apparatus including an input unit that receives a coordinate value of an optional coordinate system, and a display unit that displays information. The information processing apparatus includes a display unit that displays an instruction cursor and a plurality of icons as optional closed areas at optional coordinate positions on a screen of the display unit. The information processing apparatus includes a coordinate input unit that is used to move the instruction cursor on the screen. The information processing apparatus includes a display control unit that performs control to display the instruction cursor on an icon selected based on comparison of the length of the distance between the display coordinates of the cursor to the display coordinates of each icon in a superimposed manner.

JP2012-243164A discloses electronic equipment. The electronic equipment includes an input unit that detects a user operation and outputs a signal corresponding to the user operation. The electronic equipment includes a control unit that displays a data icon on a screen, determines a drag operation to the data icon based on the signal, and displays an icon indicating a state of the access right to data regarding the data icon on the screen corresponding to the operation.

### SUMMARY

Incidentally, the user may make a wrong operation to an image representing data displayed on the screen, and then, data may not be disclosed to a disclosure destination asked by the user.

Aspects of non-limiting embodiments of the present disclosure relate to an information processing apparatus and a non-transitory computer readable medium storing an information processing program that suppress an erroneous operation of a user to an image representing data displayed on a screen and discloses data to a disclosure destination asked by the user.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to display an area divided by disclosure range of data on a screen, execute at least one of processing of displaying the area in a different display mode by disclosure range or processing of changing a display mode of an image representing the data depending on a display position of the image on the screen, and in a case where the image is disposed in the area, disclose the data to a disclosure destination included in the disclosure range corresponding to the area.

### BRIEF DESCRIPTION OF THE DRAWINGS

Exemplary embodiment(s) of the present invention will be described in detail based on the following figures, wherein:

FIG. 1 is a block diagram showing an example of the configuration of an information processing system according to an exemplary embodiment;

FIG. 2 is a schematic view showing an example of the configuration of a disclosable range database according to the exemplary embodiment;

FIG. 3 is a schematic view showing an example of the configuration of an area database according to the exemplary embodiment;

FIG. 4 is a flowchart showing an example of information processing according to a first exemplary embodiment;

FIG. 5 is a schematic view showing an example of an area-by-disclosure-range screen according to a first exemplary embodiment;

FIG. 6 is a schematic view showing an example of a display mode change screen (an area is displayed in a different display mode by disclosure range) according to the first exemplary embodiment;

FIG. 7 is a schematic view showing an example of the display mode change screen (an icon is changed and displayed) according to the first exemplary embodiment;

FIG. 8 is a schematic view showing an example of the display mode change screen (a background color of an icon is changed) according to the first exemplary embodiment;

FIG. 9 is a schematic view showing an example of a case where disclosure range information is displayed on the display mode change screen (an icon is changed and displayed) according to the first exemplary embodiment;

FIG. 10 is a schematic view showing an example of a disclosable range change screen according to the exemplary embodiment;

FIG. 11 is a schematic view showing an example of a case where the disclosure range information is displayed on the display mode change screen (an icon is changed and displayed) in a case where an image is displayed at a predetermined distance from a different area according to the first exemplary embodiment;

FIG. 12 is a flowchart showing an example of information processing according to a second exemplary embodiment;

FIG. 13 is a schematic view showing an example of an area-by-disclosure-range screen according to the second exemplary embodiment;

FIG. 14 is a schematic view showing an example of a display mode change screen (an icon is changed and displayed) according to the second exemplary embodiment;

FIG. 15 is a schematic view showing an example of a case where the disclosure range information is displayed on the display mode change screen (an icon is changed and displayed) according to the second exemplary embodiment;

FIG. 16 is a schematic view showing an example of a disclosable range setting screen according to the second exemplary embodiment;

FIG. 17 is a flowchart showing an example of information processing according to a third exemplary embodiment;

FIG. 18 is a schematic view showing an example of an area-by-disclosure-range screen according to the third exemplary embodiment;

FIG. 19 is a schematic view showing an example of a display mode change screen (a background color of an icon is changed and displayed) according to the third exemplary embodiment; and

FIG. 20 is a schematic view showing an example of an area-by-disclosure-range screen on which three or more areas by disclosure range are displayed.

### DETAILED DESCRIPTION

Hereinafter, an example of an exemplary embodiment of the present disclosure will be described referring to the drawings. In the respective drawings, identical or equivalent elements and portions are represented by identical reference numerals. The ratio of the dimensions in the respective drawings is exaggerated for convenience of description and is different from the actual ratio in some cases.

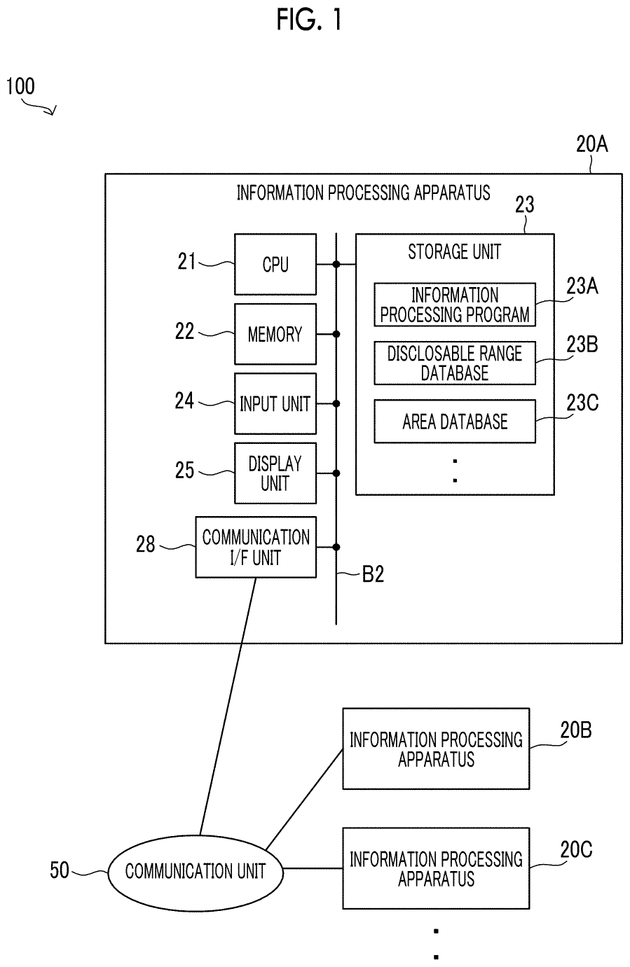

FIG. 1 is a block diagram showing an example of the hardware configuration of an information processing system according to an exemplary embodiment.

As shown in FIG. 1, an information processing system 100 according to the exemplary embodiment includes a plurality of information processing apparatuses 20A, 20B, . . . that can access a communication unit 50. Hereinafter, in a case where the information processing apparatuses 20A, 20B, . . . are not distinguished from one another, the information processing apparatuses 20A, 20B, . . . are collectively referred to as an “information processing apparatus 20”.

In the exemplary embodiment, a personal computer is applied as the information processing apparatus 20. Note that an apparatus, such as a smartphone or a tablet terminal, may be applied as the information processing apparatus 20.

The information processing apparatus 20 according to the exemplary embodiment includes a CPU 21, a memory 22 as a temporary storage area, a nonvolatile storage unit 23, an input unit 24, a display unit 25, and a communication I/F unit 28. The respective configurations are connected through a bus B2.

The storage unit 23 is realized by a storage device, such as an HDD, an SSD, or a flash memory. An information processing program 23A is stored in the storage unit 23 as a storage medium. The CPU 21 reads the information processing program 23A from the storage unit 23, expands the information processing program 23A in the memory 22, and executes processes of the information processing program 23A in sequence. In the storage unit 23, various databases, such as a disclosable range database 23B and an area database 23C, are stored. Such databases will be described below in detail.

The input unit 24 includes a pointing device, such as a mouse, and a keyboard, and is used to receive various kinds of input information.

The display unit 25 is, for example, a liquid crystal display, and displays various kinds of information. The display unit 25 may employ a touch panel system to function as the input unit 24.

The communication I/F unit 28 is an interface that is used for the information processing apparatus 20A to perform communication with other information processing apparatuses 20. For communication, for example, a wired communication standard, such as Ethernet (Registered Trademark) or FDDI, is used.

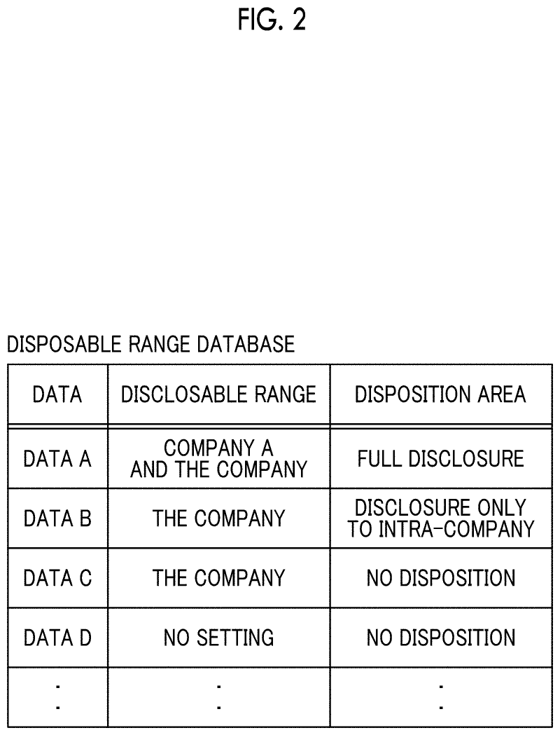

Next, the disclosable range database 23B according to the exemplary embodiment will be described referring to FIG. 2. In the disclosable range database 23B shown in FIG. 2, a setting of a disclosable range to each piece of data is stored. Specifically, as shown in FIG. 2, in the disclosable range database 23B according to the exemplary embodiment, respective kinds of information including data, a disclosable range, and a disposition area are stored in association with one another.

The data is information representing a name of data stored in the storage unit 23. The disclosable range is information indicating a target to which the data can be disclosed, set in advance for corresponding data. The disclosable range is, for example, a user or a group. Here, the group includes an organization or an association, such as a department or a company. The disclosure includes a case where a user to be a target of disclosure accesses a server where the data is stored and views details or a case where the data is transmitted to the user to be a target of disclosure. In an example shown in FIG. 2, in a case where a disclosable range is not set in advance for corresponding data, the disclosable range is represented as “no setting”. The disposition area is information indicating a name of an area by disclosure range where an image representing corresponding data is disposed, on an area-by-disclosure-range screen described below. In the example shown in FIG. 2, in a case where the image representing corresponding data is not disposed on the area-by-disclosure-range screen, the disposition area is represented as “no disposition”. In the exemplary embodiment, an icon is applied as an image representing the data.

The example shown in FIG. 2 represents that a disclosable range set in advance for data A is Company A and the company and an icon corresponding to data A is disposed in an area by disclosure range (hereinafter, referred to as a “full disclosure area”) of a name “full disclosure” on the area-by-disclosure-range screen. The example represents that a disclosable range set in advance for data B is only the company and an icon corresponding to data B is disposed in an area by disclosure range (hereinafter, referred to as an “intra-company disclosure area”) of a name “disclosure only to intra-company” on the area-by-disclosure-range screen.

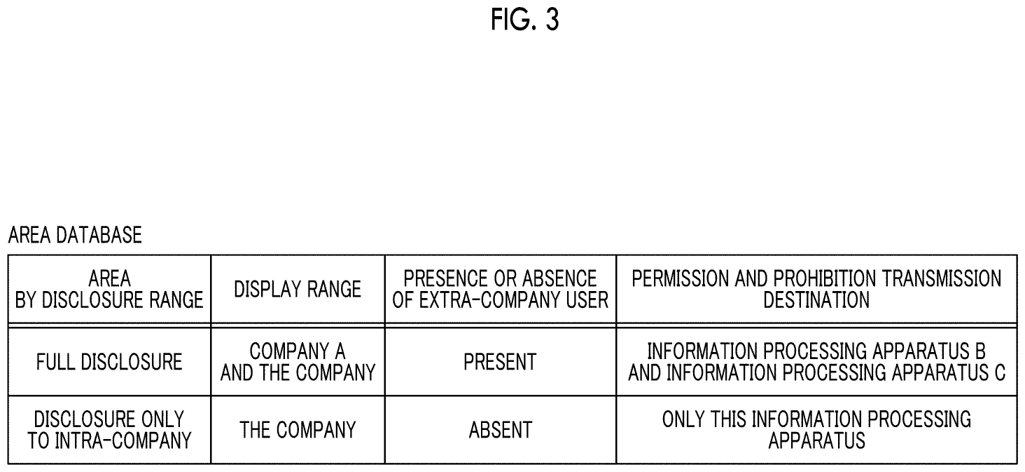

Next, the area database 23C according to the exemplary embodiment will be described referring to FIG. 3. In the area database 23C shown in FIG. 3, a setting of a disclosure range to each area by disclosure range where an icon can be disposed is stored. As shown in FIG. 3, the area database 23C according to the exemplary embodiment stores respective kinds of information including an area by disclosure range, a disclosure range, presence or absence of an extra-company user, and a permission and prohibition transmission destination in association with one another.

The area by disclosure range is information indicating a name of an area by disclosure range that is an area divided by disclosure range of data on the area-by-disclosure-range screen. The disclosure range is information indicating a target (for example, a user or a group) to which data corresponding to an icon disposed in a corresponding area by disclosure range is disclosed. The presence or absence of the extra-company user is information indicating whether or not a user other than the company is included in a corresponding disclosure range. The permission and prohibition transmission destination is information indicating a name of an information processing apparatus that, in a case where an icon is disposed in a corresponding area by disclosure range, transmits permission or prohibition of change or setting of a disclosable range of data corresponding to the icon.

An example shown in FIG. 3 represents that a disclosure range of data corresponding to an icon disposed in the full disclosure area is Company A and the company and a user other than the company is not included in the disclosure range. The example represents that, in a case where an icon is disposed in the full disclosure area, permission or prohibition of change or setting of the disclosable range of data corresponding to the icon is transmitted to an information processing apparatus 20B and an information processing apparatus 20C.

In the exemplary embodiment, the company that is a company to which a user (hereinafter, referred to as a “user”) who uses the information processing apparatus 20A belongs and Company A other than the company is applied as the disclosure range and the disclosable range. Note that an organization, an association, or the like may be applied as the disclosure range and the disclosable range. For example, only the company or only a department to which the user belongs in the company maybe applied as the disclosure range and the disclosable range. As the permission and prohibition transmission destination, information indicating whether or not there is an information processing apparatus 20 other than the information processing apparatus 20A may be applied to the transmission destination that transmits permission or prohibition of change or setting of the disclosable range of data or information indicating a name of a user of the transmission destination may be applied to the transmission destination.

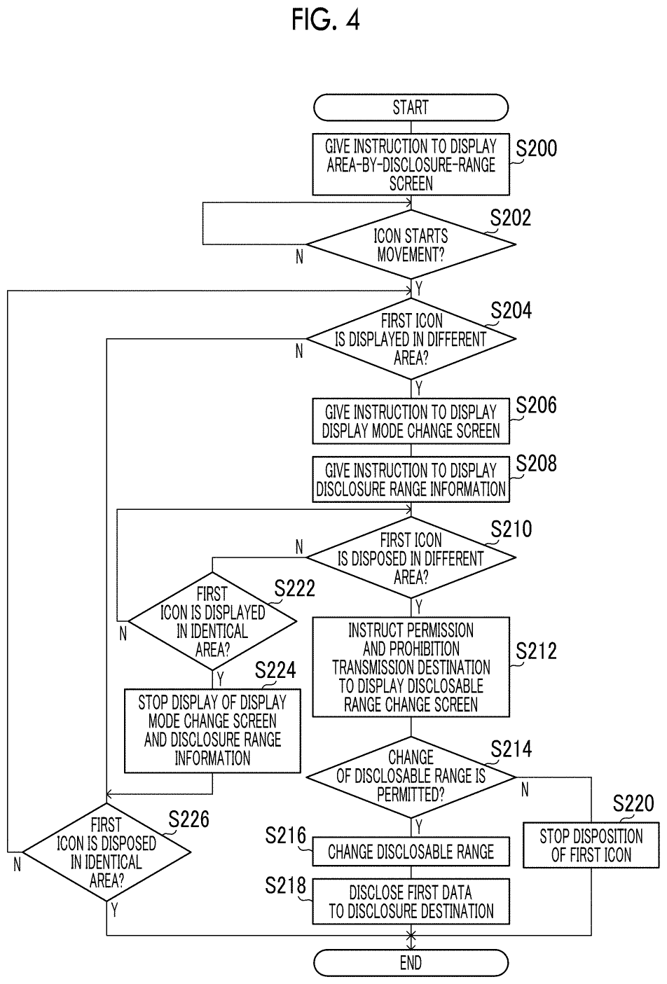

Next, the operations of the information processing apparatus 20 according to the exemplary embodiment will be described referring to FIG. 4. In a case where the user instructs the information processing apparatus 20 to execute information processing, information processing shown in FIG. 4 is executed by the CPU 21 executing the information processing program 23A.

In Step S200 of FIG. 4, the CPU 21 displays an area-by-disclosure-range screen with a predetermined format on the display unit 25.

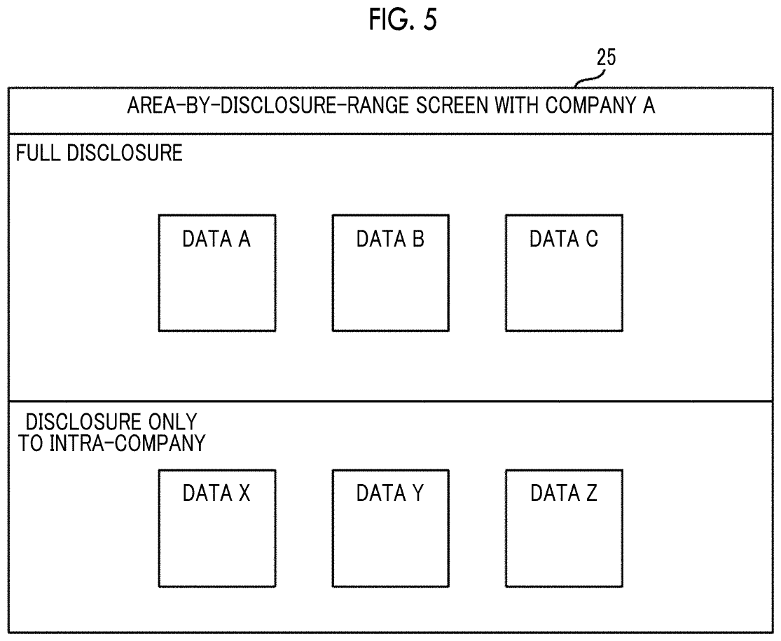

As shown in FIG. 5, on the area-by-disclosure-range screen according to the exemplary embodiment, at least areas by disclosure range and icons are displayed. The icons are disposed based on the disposition areas that correspond to data corresponding to the icons, stored in the disclosable range database 23B.

In Step S202, the CPU 21 waits until detection is made that an icon starts to move. Specifically, the CPU 21 waits until detection is made through the input unit 24 that any icon displayed on the area-by-disclosure-range screen is dragged and starts to move. In a case where detection is made that an icon starts to move, the CPU 21 starts acquisition of coordination information of the icon. Hereinafter, an icon that starts to move in the processing of Step 5202 is referred to as a first icon.

In Step S204, the CPU 21 determines whether or not the first icon is displayed in a different area that is an area different from an area where the first icon is disposed. Specifically, the CPU 21 compares the coordination information of the first icon with coordinate information of an area by disclosure range stored in advance to determine whether or not the first icon is displayed in the different area. In the exemplary embodiment, coordinate information of a center position C of the first icon is applied as the coordinate information of the first icon. Note that coordinate information of an end portion of the first icon or coordinate information of a position where the first icon is dragged by a cursor or the like may be applied as the coordinate information of the first icon. The CPU 21 progresses to Step S206 in a case where affirmative determination is made in the processing of Step S204, and progresses to Step S226 in a case where negative determination is made.

In Step S206, the CPU 21 displays a display mode change screen with a predetermined format on the display unit 25.

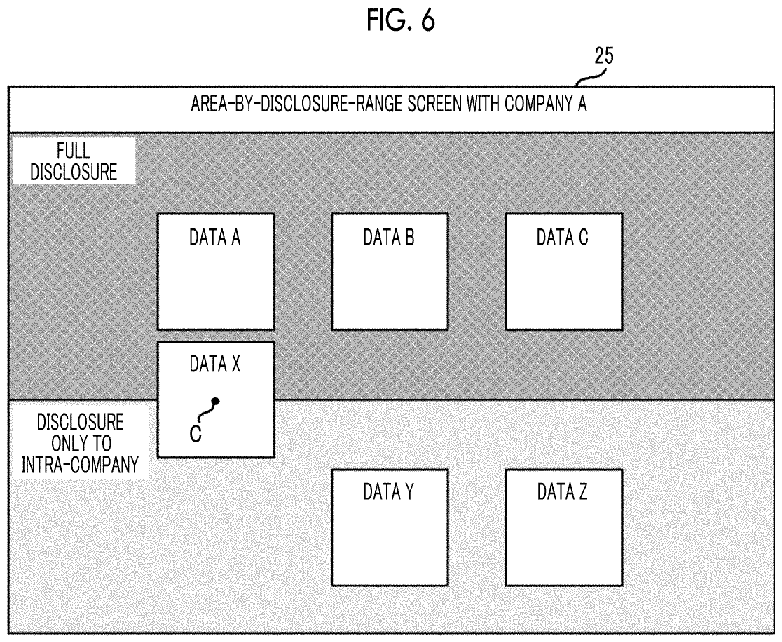

For example, as shown in FIG. 6, the areas by disclosure range are displayed in different modes on the display mode change screen according to the exemplary embodiment. In an example shown in FIG. 6, the full disclosure area is displayed in a mode with a dark color and a pattern compared to the intra-company disclosure area.

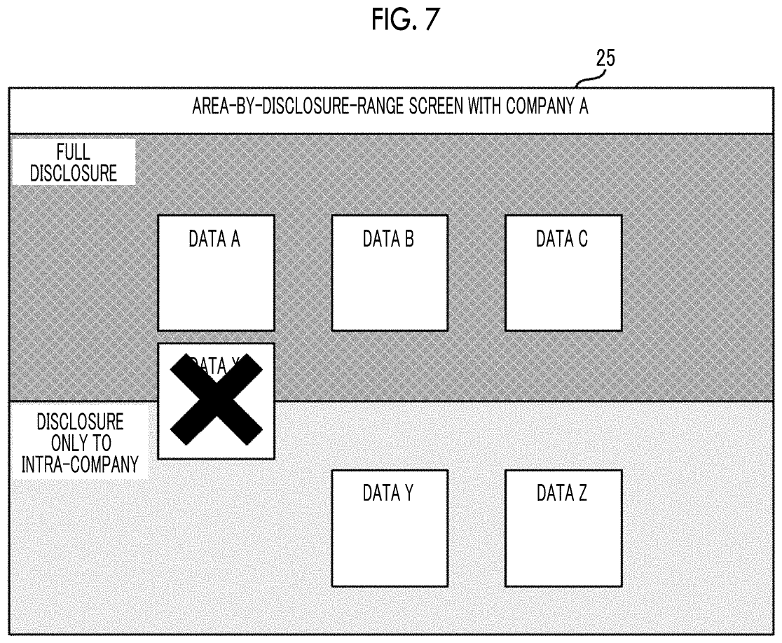

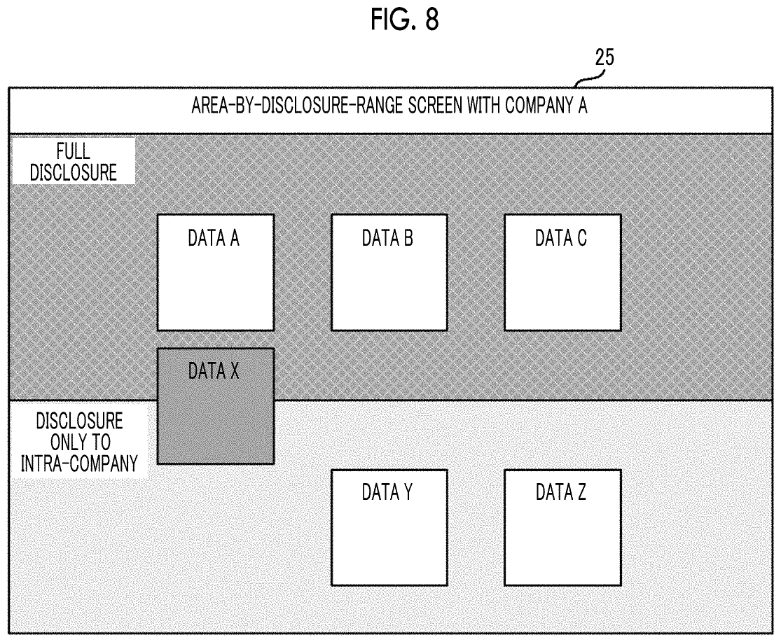

The display mode change screen according to the exemplary embodiment is not limited to the example shown in FIG. 6. For example, as shown in FIGS. 7 and 8, on the display mode change screen according to the exemplary embodiment, the areas by disclosure range may be displayed in different modes, and a display mode of the first icon may be changed and displayed. In an example shown in FIG. 7, an x mark is displayed on the first icon in a superimposed manner. In an example shown in FIG. 8, a background color of the first color is changed and displayed. The display mode of the first icon is not limited to the example shown in FIG. 7 or 8. Specifically, a mode where the first icon blinks or a mode where such display modes may be used alone or in combination may be applied as the display mode of the first icon. On the display mode change screen according to the exemplary embodiment, the areas by disclosure range may not be displayed in different modes, and only the display mode of the first icon may be changed and displayed.

In Step S208, the CPU 21 displays disclosure range information on the display mode change screen. Specifically, the CPU 21 reads the area database 23C and displays the disclosure range information that includes the disclosure range corresponding to the different area, the presence or absence of the extra-company user, and the permission and prohibition transmission destination, on the display mode change screen. Update date and time of the disclosure range maybe applied as the disclosure range information in addition to the above-described information or such information may be applied alone or in combination. The CPU 21 may display information regarding update date and time, an editor, or the like of the first data on the display mode change screen in addition to the disclosure range information.

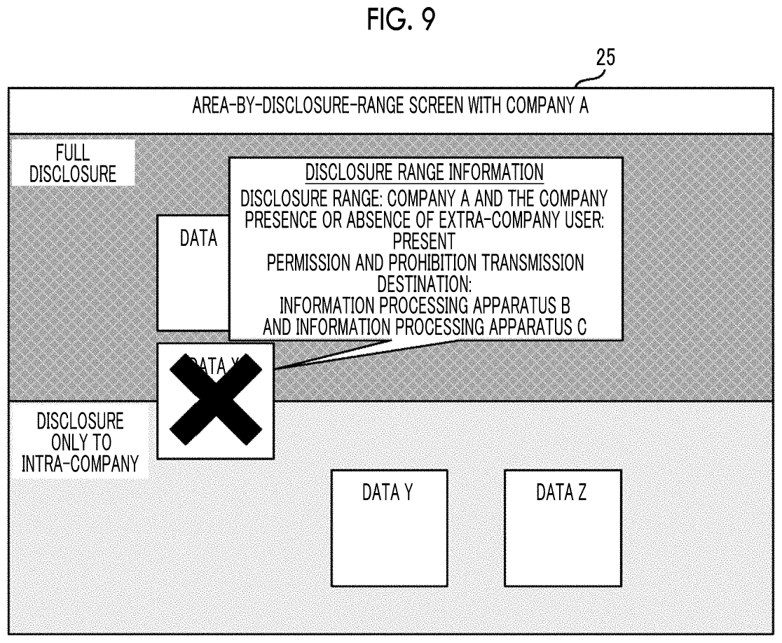

In an example shown in FIG. 9, as disclosure range information corresponding to the full disclosure area that is a different area, information indicating that the disclosure range is Company A and the company, an extra-company user is present, and the permission and prohibition transmission destination is the information processing apparatus 20B and the information processing apparatus 20C is displayed on the display mode change screen.

In Step S210, the CPU 21 determines that the first icon is disposed in the different area. Specifically, the CPU 21 determines whether or not the first icon is dropped in the different area, through the input unit 24. In a case where affirmative determination is made in the processing of Step S210, the CPU 21 progresses to Step S212.

In Step S212, the CPU 21 instructs a permission and prohibition transmission destination to display the disclosable range change screen with a predetermined format. Specifically, the CPU 21 instructs the permission and prohibition transmission destination corresponding to the different area in the area database 23C to display the disclosable range change screen with a predetermined format.

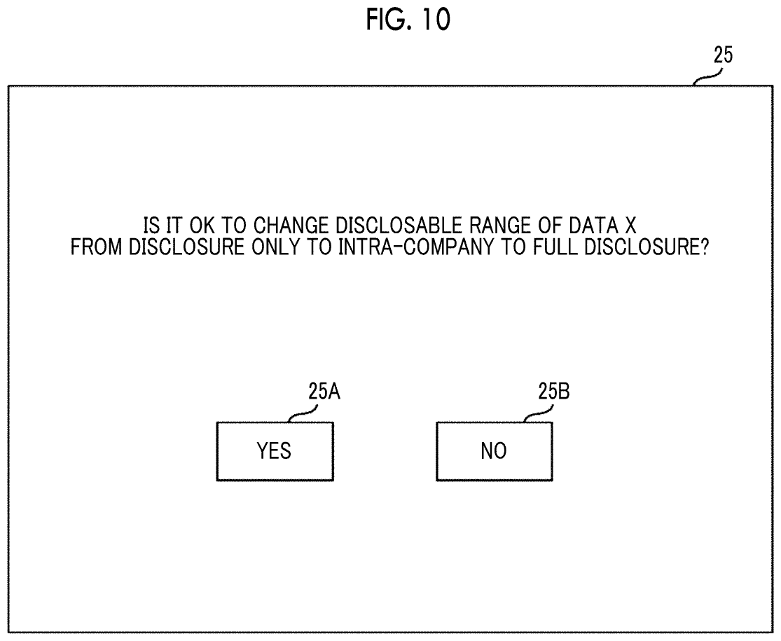

As shown in FIG. 10, on a disclosable range change screen according to the exemplary embodiment, a message for prompting selection of permission or prohibition of change of the disclosable range of the first data from the disclosable range set in advance to the disclosure range corresponding to the different area is displayed. As an example, in a case where the permission and prohibition transmission destination is the information processing apparatus 20A, the disclosable range change screen shown in FIG. 10 is displayed on the display unit 25.

The user selects a YES button 25A in a case of permitting the change and selects a NO button 25B in a case of not permitting the change, through the input unit 24.

In Step S214, the CPU 21 determines whether or not the change of the disclosable range is permitted. In a case where affirmative determination is made in the processing of Step S214, the CPU 21 progresses to Step S216.

In Step S216, the CPU 21 changes the disclosable range corresponding to the first data in the disclosable range database 23B to the disclosure range corresponding to the different area and changes the disposition area corresponding to the first data to the different area.

In Step S218, the CPU 21 discloses the first data to a disclosure destination included in the disclosure range corresponding to the different area and ends the information processing.

On the other hand, in a case where negative determination is made in the processing of Step S214, the CPU 21 progresses to Step S220. In Step S220, the CPU 21 stops the disposition of the first icon in the different area and ends the information processing. Specifically, the CPU 21 disposes the first icon in an area (hereinafter, referred to as an “identical area”) where the first icon is disposed before the start of the movement and ends the information processing.

In a case where negative determination is made in the processing of Step S210, the CPU 21 progresses to Step S222. In Step S222, the CPU 21 determines whether or not the first icon is displayed in the identical area. The CPU 21 progresses to Step S224 in a case where affirmative determination is made in the processing of Step S222, and returns to Step S210 in a case where negative determination is made.

In Step S224, the CPU 21 stops the display of the display mode change screen and the disclosure range information.

In Step S226, the CPU 21 determines whether or not the first icon is disposed in the identical area. The CPU 21 ends the information processing in a case where affirmative determination is made in the processing of Step S226, and returns to Step S204 in a case where negative determination is made.

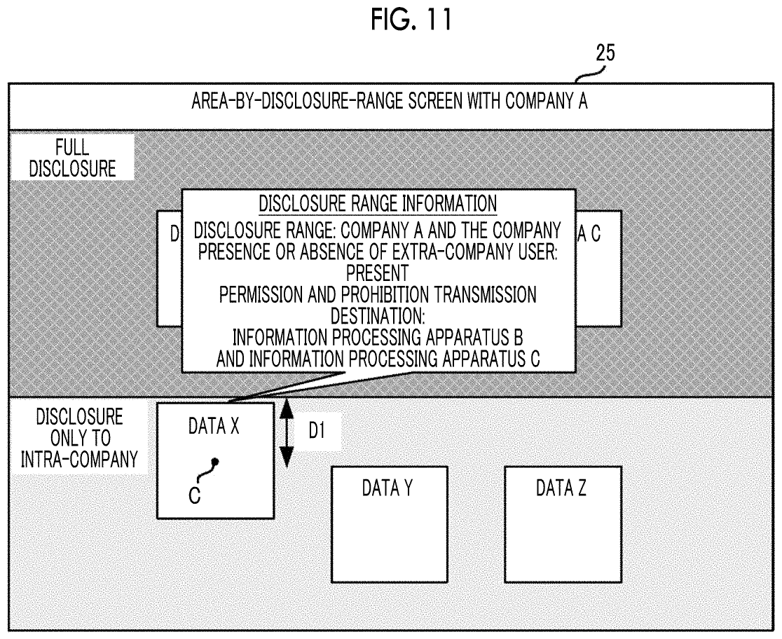

In the exemplary embodiment, in a case where the first icon is displayed in the different area (Step S204: Y), the CPU 21 displays the display mode change screen. Note that, in a case where the first icon is displayed at a predetermined distance from the different area, the CPU 21 may display the display mode change screen. In other words, in a case where a possibility that the first icon is displayed in the different area is higher than before the start of the movement, the CPU 21 may display the display mode change screen. Specifically, in a case where the first icon is displayed at a predetermined distance from the different area, the CPU 21 may execute at least one of processing of displaying the area by disclosure range in a different mode or processing of changing a display mode of the first icon. In a case where the first icon is displayed at the predetermined distance from the different area, the CPU 21 may display the disclosure range information on the screen. In an example shown in FIG. 11, in a case where the center position C of the first icon is displayed at a predetermined distance D1 from the boundary between the different area and the identical area, the area by disclosure range is displayed in a different mode, and the disclosure range information is displayed on the display mode change screen.

### Second Exemplary Embodiment

A second exemplary embodiment is different from the first exemplary embodiment in that, in a case where an icon of data is displayed in an area corresponding to a disclosure range beyond a disclosable range set in advance for data (that is, a disclosure range including a disclosure target that is not included in a target indicated by the disclosable range), the display mode change screen is displayed. Details will be described below.

The hardware configuration of the information processing apparatus 20 according to the exemplary embodiment is identical to the configuration (see FIGS. 1 to 3) according to the first exemplary embodiment, and thus, description thereof will not be repeated.

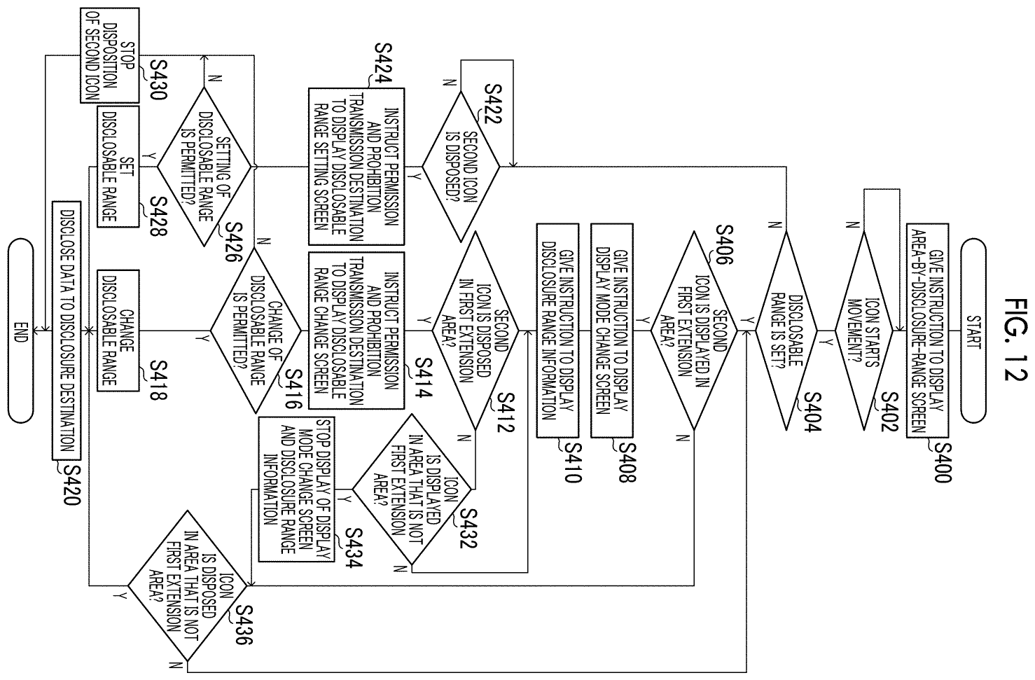

The operations of the information processing apparatus 20 according to the exemplary embodiment will be described referring to FIG. 12. In the exemplary embodiment, a case where an icon that is not disposed in advance on the area-by-disclosure-range screen is displayed on the screen will be described. Note that, like the first exemplary embodiment, the exemplary embodiment may be applied to a case where an icon that is disposed in advance on the area-by-disclosure-range screen is moved within the screen.

In Step S400 of FIG. 12, the CPU 21 displays an area-by-disclosure-range screen with a predetermined format on the display unit 25.

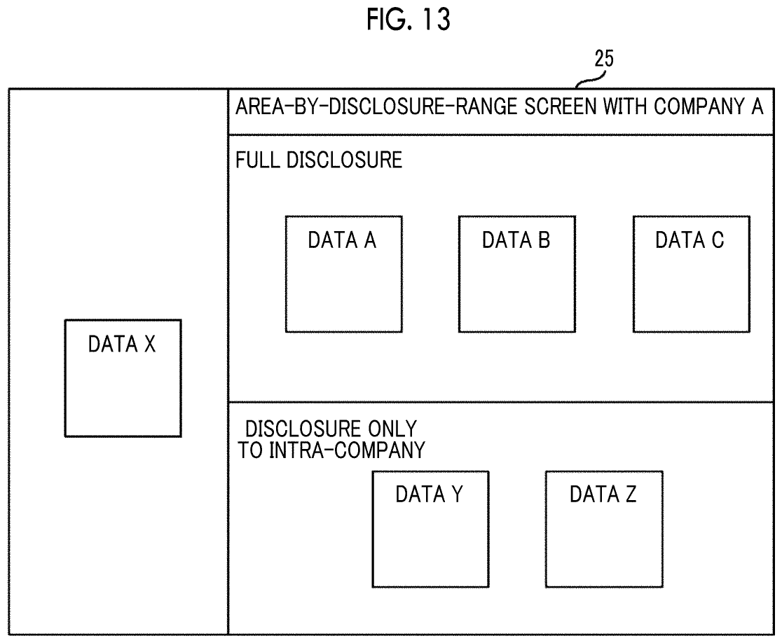

As shown in FIG. 13, on the area-by-disclosure-range screen according to the exemplary embodiment, at least areas by disclosure range and icons are displayed. The exemplary embodiment is different from the first exemplary embodiment in that an icon (in an example shown in FIG. 13, “data X”) that is not disposed on the area-by-disclosure-range screen is displayed on the display unit 25.

In Step S402, the CPU 21 waits until detection is made that an icon starts to move. Specifically, the CPU 21 waits until detection is made through the input unit 24 that any icon that is not disposed in advance on the area-by-disclosure-range screen is dragged. In a case where detection is made that an icon starts to move, the CPU 21 starts acquisition of coordination information of the icon. Hereinafter, the icon that starts to move in the processing of Step S402 is referred to as a second icon.

The CPU 21 may not display the area-by-disclosure-range screen and the second icon on the display unit 25 simultaneously. For example, the CPU 21 may display the area-by-disclosure-range screen after an instruction to move the second icon onto the area-by-disclosure-range screen is received.

In Step S404, the CPU 21 determines whether or not a disclosable range is set in advance for data (hereinafter, referred to as second data) corresponding to the second icon. Specifically, the CPU 21 reads the disclosable range corresponding to the second data from the disclosable range database 23B and determines whether or not the disclosable range is set for the second data. In a case where affirmative determination is made in the processing of Step S404, the CPU 21 progresses to Step S406.

In Step S406, the CPU 21 determines whether or not the second icon is displayed in a first extension area that is an area corresponding to a disclosure range beyond the disclosable range set in advance for the second data. For example, in a case where the disclosable range set in advance for the second data is only the company, and in a case where the second icon is displayed in the full disclosure area, affirmative determination is made in the processing of Step S406. On the other hand, in a case where the disclosable range set in advance for the second data is Company A and the company, and in a case where the second icon is displayed in the intra-company disclosure area, negative determination is made in the processing of Step S406. The CPU 21 progresses to Step S408 in a case where affirmative determination is made in the processing of Step S406, and progress to Step S436 described below in a case where negative determination is made.

In Step S408, the CPU 21 displays a display mode change screen with a predetermined format on the display unit 25.

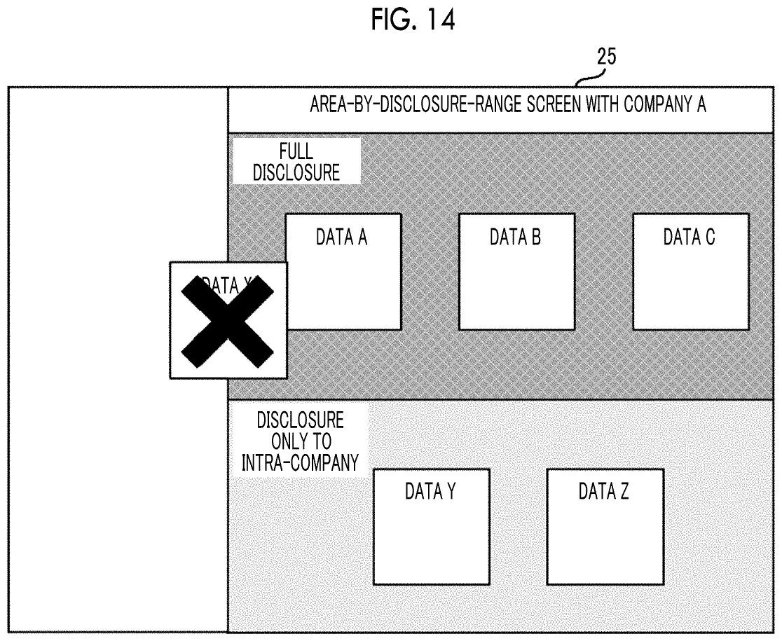

As shown in FIG. 14, on a display mode change screen according to the exemplary embodiment, the area by disclosure range is displayed in a different mode on the area-by-disclosure-range screen, and a display mode of the second icon is changed and displayed (in an example shown in FIG. 14, an x mark is displayed on the second icon in a superimposed manner). Note that the CPU 21 may execute only the processing of displaying the area by disclosure range in a different mode or the processing of changing the display mode of the second icon.

In Step S410, the CPU 21 displays disclosure range information on the display mode change screen. Specifically, the CPU 21 reads the area database 23C and displays disclosure range information corresponding to the first extension area on the display mode change screen.

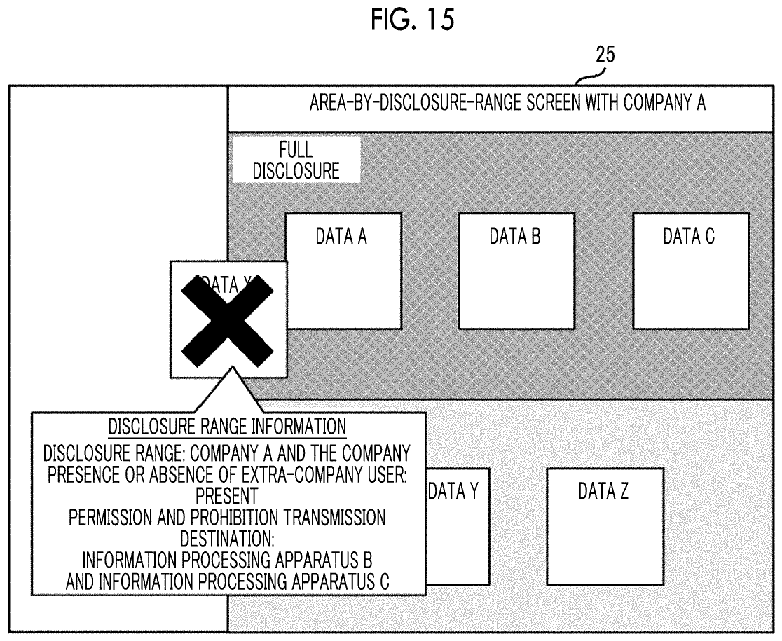

In an example shown in FIG. 15, as the disclosure range information corresponding to the full disclosure area that is the first extension area, information indicating that the disclosure range is Company A and the company, an extra-company user is present, and the permission and prohibition transmission destination is the information processing apparatus 20B and the information processing apparatus 20C is displayed on the display mode change screen.

In Step S412, the CPU 21 determines whether or not the second icon is disposed in the first extension area. Specifically, the CPU 21 determines whether or not the second icon is dropped in the first extension area, through the input unit 24. In a case where affirmative determination is made in the processing of Step S412, the CPU 21 progresses to Step S414.

In Step S414, the CPU 21 instructs a permission and prohibition transmission destination to display a disclosable range change screen with a predetermined format. Specifically, the CPU 21 instructs the permission and prohibition transmission destination corresponding to the first extension area in the area database 23C to display the disclosable range change screen with a predetermined format. The disclosable range change screen in the exemplary embodiment has the same configuration as the disclosable range change screen according to the first exemplary embodiment, and thus, illustration thereof will not be repeated.

In Step S416, the CPU 21 determines whether or not the change of the disclosable range is permitted. The CPU 21 progresses to Step S418 in a case where affirmative determination is made in the processing of Step S416, and progresses to Step S430 in a case where negative determination is made.

In Step S418, the CPU 21 changes the disclosable range corresponding to the second data in the disclosable range database 23B to a disclosure range corresponding to the first extension area and changes the disposition area corresponding to the second data to the first extension area.

In Step S420, the CPU 21 discloses the second data to a disclosure destination included in the disclosure range corresponding to the area where the second icon is disposed and ends the information processing.

On the other hand, in a case where negative determination is made in the processing of Step S404, the CPU 21 progresses to Step S422. In Step S422, the CPU 21 waits until the second icon is disposed on the area-by-disclosure-range screen.

In Step S424, the CPU 21 instructs a permission and prohibition transmission destination to display a disclosable range setting screen with a predetermined format. Specifically, the CPU 21 reads the permission and prohibition transmission destination corresponding to the area where the second icon is disposed in the processing of Step S422, from the area database 23C, and instructs the permission and prohibition transmission destination to display the disclosable range setting screen with a predetermined format.

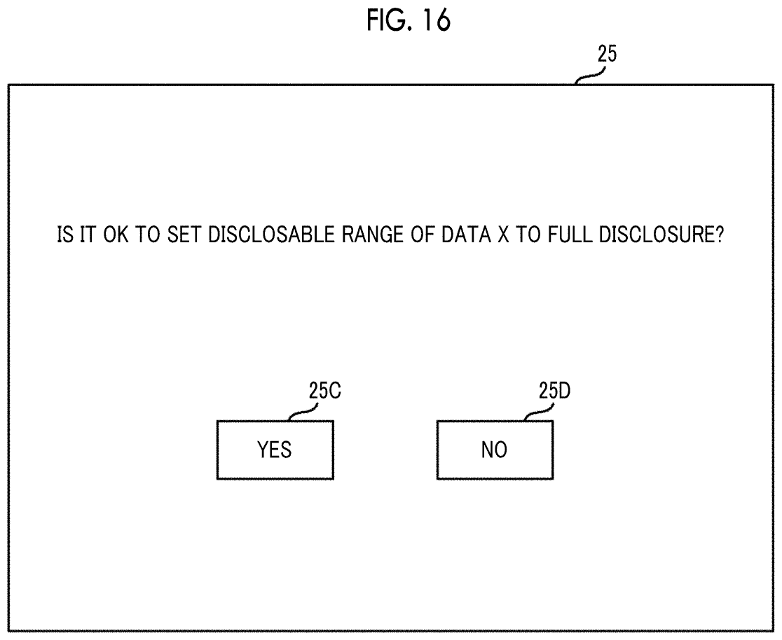

As shown in FIG. 16, on the disclosable range setting screen according to the exemplary embodiment, a message for prompting selection of permission or prohibition of setting of the disclosable range of the second data to the disclosure range corresponding to the area where the second icon is disposed in the processing of Step S422 is displayed. As an example, in a case where the permission and prohibition transmission destination is the information processing apparatus 20A, the disclosable range setting screen shown in FIG. 16 is displayed on the display unit 25. The user selects a YES button 25C in a case of permitting the setting and selects a NO button 25D in a case of not permitting the setting, through the input unit 24.

In Step S426, the CPU 21 determines whether or not the setting of the disclosable range is permitted. The CPU 21 progresses to Step S428 in a case where affirmative determination is made in the processing of Step S426, and progresses to Step S430 in a case where negative determination is made.

In Step S428, the CPU 21 sets the disclosable range corresponding to the second data in the disclosable range database 23B to the disclosure range corresponding to the area where the second icon is disposed in the processing of Step S422. The CPU 21 sets the disposition area corresponding to the second data to the area where the second icon is disposed in the processing of Step S422.

In Step S430, the CPU 21 stops the disposition of the second icon and ends the information processing. Specifically, the CPU 21 returns the second icon to the position where the second icon is disposed before the start of the movement and ends the information processing.

On the other hand, the CPU 21 progresses to Step S432 in a case where negative determination is made in the processing of Step S412. In Step S432, the CPU 21 determines whether or not the second icon is displayed in an area that is not the first extension area. The CPU 21 progresses to Step S434 in a case where affirmative determination is made in the processing of Step S432, and returns to Step S412 in a case where negative determination is made.

In Step S434, the CPU 21 stops the display of the display mode change screen and the disclosure range information.

In Step S436, the CPU 21 determines whether or not the second icon is disposed in an area that is not the first extension area. The CPU 21 progresses to Step S420 in a case where affirmative determination is made in the processing of Step S436, and returns to Step S406 in a case where negative determination is made.

In the exemplary embodiment, in a case where the second icon is displayed in the first extension area (Step S406: Y), the CPU 21 displays the display mode change screen. Note that, in a case where the second icon is displayed at a predetermined distance from the first extension area, the CPU 21 may display the display mode change screen. In other words, in a case where a possibility that the second icon is displayed in the first extension area is higher than before the start of the movement, the CPU 21 may display the display mode change screen. Specifically, in a case where the second icon is displayed at the predetermined distance from the first extension area, the CPU 21 may execute at least one of processing of displaying the area by disclosure range in a different mode or processing of changing the display mode of the second icon. In a case where the second icon is displayed at the predetermined distance from the first extension area, the CPU 21 may display the disclosure range information on the screen.

### Third Exemplary Embodiment

A third exemplary embodiment is different from the first exemplary embodiment in that a range of an area by disclosure range is changed. Details will be described below.

The hardware configuration of the information processing apparatus 20 according to the exemplary embodiment is identical to the configuration (see FIGS. 1 to 3) according to the first exemplary embodiment, and thus, description thereof will not be repeated.

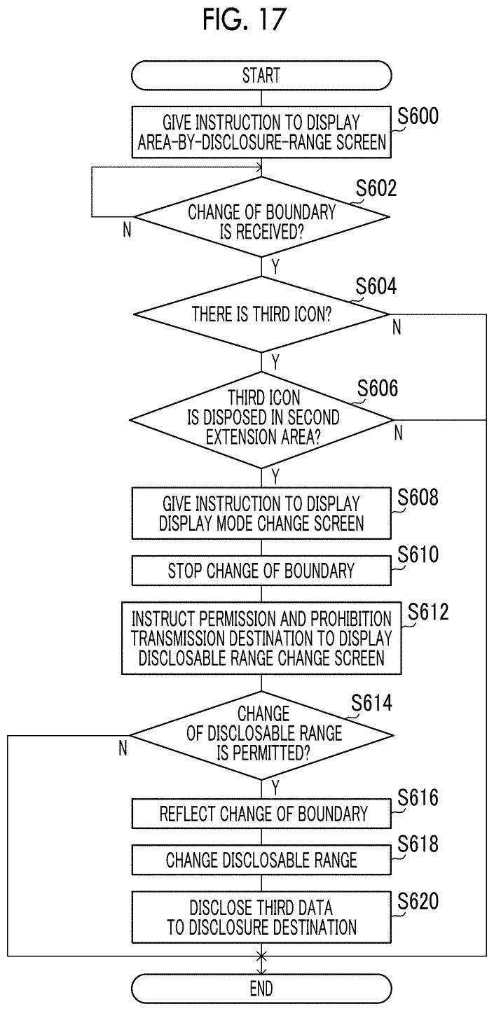

The operations of the information processing apparatus 20 according to the exemplary embodiment will be described referring to FIG. 17.

In Step S600 of FIG. 17, the CPU 21 displays an area-by-disclosure-range screen with a predetermined format on the display unit 25.

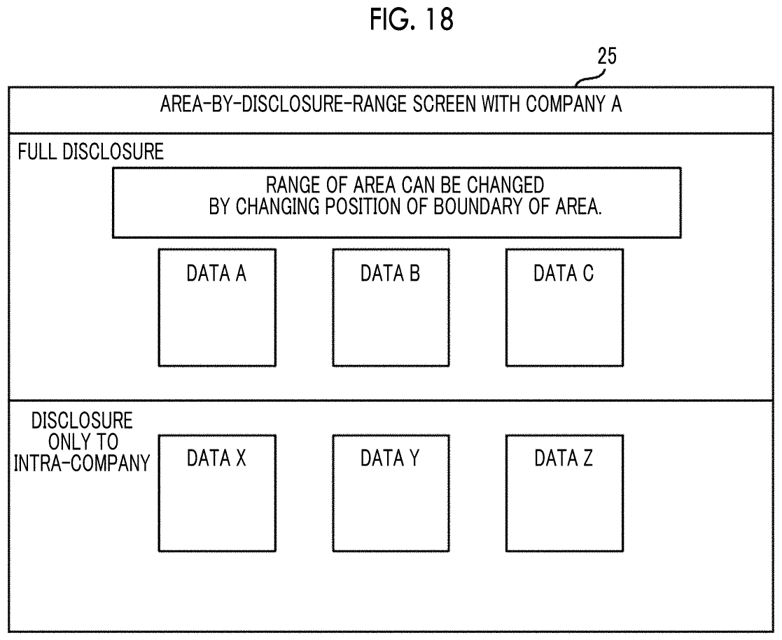

As shown in FIG. 18, on the area-by-disclosure-range screen according to the exemplary embodiment, unlike the area-by-disclosure-range screen according to the first exemplary embodiment, a message indicating that change of a position of a boundary representing a range of an area by disclosure range can change the range of the area is displayed.

In Step S602, the CPU 21 waits until change of a position of a boundary is received. Specifically, the CPU 21 waits until detection is made through the input unit 24 that the boundary is dragged and dropped.

In Step S604, the CPU 21 determines whether or not there is a third icon that is an icon the disposition area of which is changed with the change of the range of the area by disclosure range. The CPU 21 progresses to Step S606 in a case where affirmative determination is made in the processing of Step S604, and ends the information processing in a case where negative determination is made.

In Step S606, the CPU 21 determines whether or not the third icon is disposed in a second extension area that is an area corresponding to a disclosure range beyond a disclosable range set in advance for third data as data corresponding to the third icon. The CPU 21 progresses to Step S608 in a case where affirmative determination is made in the processing of Step S606, and ends the information processing in a case where negative determination is made.

In Step S608, the CPU 21 displays a display mode change screen with a predetermined format on the display unit 25.

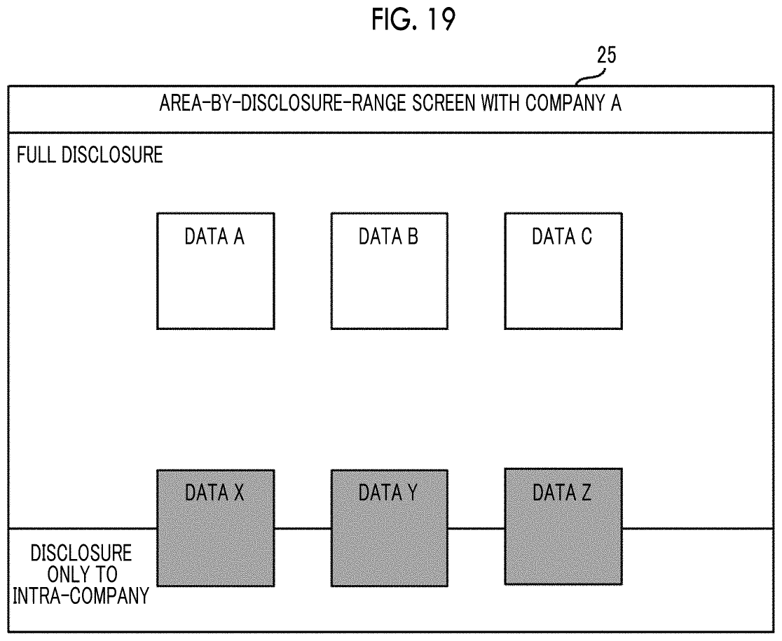

As shown in FIG. 19, on the display mode change screen according to the exemplary embodiment, a display mode of the third icon is changed and displayed (in an example shown in FIG. 19, the background color of data X, data Y, and data Z as the third icon is changed and displayed). Note that the CPU 21 may execute processing of displaying the area by disclosure range in a different mode or may execute processing of displaying the area by disclosure range in a different mode and processing of changing the display mode of the third icon. The CPU 21 may not display the display mode change screen on the display unit 25.

In Step S610, the CPU 21 stops the change of the position of the boundary received in the processing of Step S602 and returns the boundary to a position disposed before the change.

In Step S612, the CPU 21 instructs a permission and prohibition transmission destination to a disclosable range change screen with a predetermined format. Specifically, the CPU 21 reads the permission and prohibition transmission destination corresponding to the area where the third icon is disposed in the processing of Step S604, from the area database 23C, and instructs the permission and prohibition transmission destination to display the disclosable range change screen with a predetermined format. The disclosable range change screen in the exemplary embodiment has the same configuration as the disclosable range change screen according to the first exemplary embodiment, and thus, illustration thereof will not be repeated.

In Step S614, the CPU 21 determines whether or not the change of the disclosable range is permitted. The CPU 21 progresses to Step S616 in a case where affirmative determination is made in the processing of Step S614, and ends the information processing in a case where negative determination is made.

In Step S616, the CPU 21 reflects the change of the position of the boundary received in the processing of Step S602. Specifically, the CPU 21 cancels the stop to reflect the change of the position of the boundary in the processing of Step S610 to reflect the change of the position of the boundary received in the processing of Step S602.

In Step S618, the CPU 21 changes the disclosable range corresponding to the third data in the disclosable range database 23B to the disclosure range corresponding to the area where the third icon is disposed in the processing of Step S606. The CPU 21 changes the disposition area corresponding to the third data to the area where the third icon is disposed in the processing of Step S606.

In Step S620, the CPU 21 discloses the third data to a disclosure destination included in the disclosure range corresponding to the area where the third icon is disposed and ends the information processing.

In the exemplary embodiment, in a case where the third icon is disposed in the second extension area (Step S606: Y), the CPU 21 displays the display mode change screen. Note that, in a case where the third icon is disposed at a predetermined distance from the second extension area, the CPU 21 may display the display mode change screen. In other words, in a case where a possibility that the third icon is displayed in the second extension area is higher than before the change of the position of the boundary, the CPU 21 may display the display mode change screen. Specifically, in a case where the third icon is disposed at the predetermined distance from the second extension area, the CPU 21 may execute at least one of processing of displaying the area by disclosure range in a different mode or processing of changing the display mode of the third icon.

Although the exemplary embodiments have been described above, the technical scope of the invention is not limited to the scope described in the above-described exemplary embodiments. Various modifications or improvements can be made to the above-described exemplary embodiments without departing from the spirit of the invention, and any embodiments obtained such modifications or improvements are also included in the technical scope of the invention.

The above-described exemplary embodiments do not limit the invention according to the claims, and all combinations of features described in the exemplary embodiments are not always required for the means for addressing the invention. The above-described exemplary embodiments include various stages of invention, and various inventions are extracted by combinations of a plurality of constituents disclosed in the exemplary embodiments. Even though several constituents are removed from all constituents illustrated in the exemplary embodiments, a configuration in which several constituents are removed can be extracted as an invention as long as an effect is achieved.

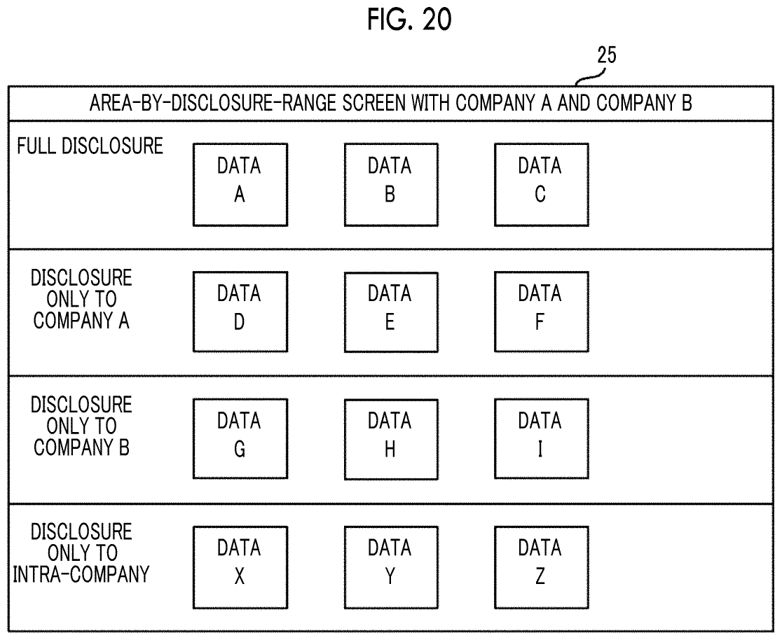

For example, in the above-described exemplary embodiments, the screen on which the two areas by disclosure range including the full disclosure area where the disclosable range is Company A and the company and the intra-company disclosure area where the disclosable range is only the company are displayed is applied as the area-by-disclosure-range screen. Note that a screen on which three or more disclosable ranges are displayed may be applied as the area-by-disclosure-range screen. For example, as shown in FIG. 20, in addition to the full disclosure area and the intra-company disclosure area, as an area where data is not disclosed to the company, an area where the disclosure range is only Company A and an area where the disclosure range is only Company B may be displayed on the area-by-disclosure-range screen. In an example shown in FIG. 20, icons corresponding to data A, data B, and data C are disposed in the full disclosure area, and icons corresponding to data D, data E, and data F are disposed in the area where the disclosure range is only Company A. In the example shown in FIG. 20, icons corresponding to data G, data H, and data I are disposed in the area where the disclosure range is only Company B, and icons corresponding to data X, data Y, and data Z are disposed in the intra-company disclosure area.

In a case where the first icon is displayed in the different area or at a predetermined distance from the different area or in a case where the second icon is displayed in the first extension area or at a predetermined distance from the first extension area, the CPU 21 may present an indication that the first icon or the second icon is displayed, by sound. Alternatively, the CPU 21 may vibrate the mouse in the input unit 24 in a case where the first icon or the second icon is displayed. In a case where the third icon is disposed in the second extension area or at a predetermined distance from the second extension area, the CPU 21 may present an indication that the third icon is disposed, by sound or may vibrate the mouse in the input unit 24.

The CPU 21 may display the display mode change screen on which the area by disclosure range is displayed in a different mode, immediately after the information processing is executed. Alternatively, in a case where the first icon or the second icon starts to move or in a case where the boundary change is received, the CPU 21 may display the display mode change screen on which the area by disclosure range is displayed in a different mode.

The CPU 21 may change the display mode of the first icon depending on a display position of the first icon. Specifically, the CPU 21 may execute processing of making the background color of the first icon darker as a distance between the first icon and the different area is closer, after the start of the movement of the first icon. Likewise, the CPU 21 may change the display mode of the second icon depending on the display position of the first icon.

In the above-described exemplary embodiments, determination regarding whether or not to display the display mode change screen on the display unit 25 is performed depending on the disclosable range or the disposition area stored in the disclosable range database 23B. Note that determination regarding whether or not to display the display mode change screen on the display unit 25 may be performed based on text information in the first data, the second data, or the third data. Specifically, in a case where there is predetermined text information “momentous”, “confidential”, or the like in the data or in a case where personal information is included in the data, the CPU 21 may display the display mode change screen on the display unit 25.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the exemplary embodiments, although an embodiment in which the information processing program 23A is installed on the storage unit 23, the invention is not limited thereto. The information processing program 23A according to the exemplary embodiment may be provided in a form of being recorded on a computer readable storage medium. For example, the information processing program 23A according to the exemplary embodiment may be provided in a form of being recorded on an optical disc, such as a compact disc (CD)-ROM or a digital versatile disc (DVD)-ROM, or a form of being recorded on a semiconductor memory, such as a universal serial bus (USB) memory or a memory card. The information processing program 23A according to the exemplary embodiment may be acquired from an external apparatus through the communication I/F unit 28.

In the above-described exemplary embodiments, although a case where the information processing is realized by a software configuration using a computer by executing the program has been described, the invention is not limited thereto. For example, an embodiment may be made in which the information processing is realized by a hardware configuration or a combination of a hardware configuration and a software configuration.

In addition, the configuration of the information processing apparatus 20 described in the above-described exemplary embodiment is just an example, and it is needless to say that unnecessary portions may be removed new portions may be added without departing from the spirit of the invention.

The flow (see FIGS. 4, 12, and 17) of the processing of the information processing program described in the above-described exemplary embodiments is just an example, it is needless to say that unnecessary steps may be removed, new steps may be added, or the processing order may be changed without departing from the spirit of the invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
display an area divided by disclosure range of data on a screen;
execute at least one of processing of displaying the area in a different display mode by disclosure range or processing of changing a display mode of an image representing the data depending on a display position of the image on the screen; and
in a case where the image is disposed in the area, disclose the data to a disclosure destination included in the disclosure range corresponding to the area.

2. The information processing apparatus according to claim 1, wherein the processor is configured to:
in a case where the image is displayed in an area different from the area where the image is disposed, execute at least one of the processing of displaying the area in a different mode by disclosure range or the processing of changing the display mode of the image depending on the display position of the image.

3. The information processing apparatus according to claim 1, wherein the processor is configured to:
in a case where the image is displayed in an area different from the area where the image is disposed, display information regarding a disclosure range corresponding to the different area.

4. The information processing apparatus according to claim 2, wherein the processor is configured to:
in a case where the image is displayed in an area different from the area where the image is disposed, display information regarding a disclosure range corresponding to the different area.

5. The information processing apparatus according to claim 1, wherein the processor is configured to:
in a case where the image is displayed at a predetermined distance from an area different from the area where the image is disposed, execute at least one of the processing of displaying the area in a different mode by disclosure range or the processing of changing the display mode of the image depending on the display position of the image.

6. The information processing apparatus according to claim 2, wherein the processor is configured to:
in a case where the image is displayed at a predetermined distance from an area different from the area where the image is disposed, execute at least one of the processing of displaying the area in a different mode by disclosure range or the processing of changing the display mode of the image depending on the display position of the image.

7. The information processing apparatus according to claim 3, wherein the processor is configured to:
in a case where the image is displayed at a predetermined distance from an area different from the area where the image is disposed, execute at least one of the processing of displaying the area in a different mode by disclosure range or the processing of changing the display mode of the image depending on the display position of the image.

8. The information processing apparatus according to claim 4, wherein the processor is configured to:
in a case where the image is displayed at a predetermined distance from an area different from the area where the image is disposed, execute at least one of the processing of displaying the area in a different mode by disclosure range or the processing of changing the display mode of the image depending on the display position of the image.

9. The information processing apparatus according to claim 1, wherein the processor is configured to:
in a case where the image is displayed at a predetermined distance from an area different from the area where the image is disposed, display information regarding a disclosure range corresponding to the different area.

10. The information processing apparatus according to claim 2, wherein the processor is configured to:
in a case where the image is displayed at a predetermined distance from an area different from the area where the image is disposed, display information regarding a disclosure range corresponding to the different area.

11. The information processing apparatus according to claim 3, wherein the processor is configured to:
in a case where the image is displayed at a predetermined distance from an area different from the area where the image is disposed, display information regarding a disclosure range corresponding to the different area.

12. The information processing apparatus according to claim 4, wherein the processor is configured to:
in a case where the image is displayed at a predetermined distance from an area different from the area where the image is disposed, display information regarding a disclosure range corresponding to the different area.

13. The information processing apparatus according to claim 5, wherein the processor is configured to:
in a case where the image is displayed at a predetermined distance from an area different from the area where the image is disposed, display information regarding a disclosure range corresponding to the different area.

14. The information processing apparatus according to claim 1,
wherein a disclosable range is set in advance for the data, and
the processor is configured to:
in a case where the image representing the data is displayed in an area corresponding to a disclosure range beyond the disclosable range, execute at least one of the processing of displaying the area in a different mode by disclosure range or the processing of changing the display mode of the image depending on the display position of the image.

15. The information processing apparatus according to claim 1,
wherein a disclosable range is set in advance for the data, and
the processor is configured to:
in a case where the image representing the data is displayed in an area corresponding to a disclosure range beyond the disclosable range, display information regarding the disclosure range corresponding to the area.

16. The information processing apparatus according to claim 14, wherein the processor is configured to:
in a case where the image representing the data is disposed in an area corresponding to a disclosure range beyond the disclosable range, change the disclosable range of the data depending on the disclosure range.

17. The information processing apparatus according to claim 1, wherein the processor is configured to:
receive change of a position of a boundary representing a range of the area, and
the range of the area is changed in compliance with the received change of the position of the boundary.

18. The information processing apparatus according to claim 17,
wherein a disclosable range is set in advance for the data, and
the processor is configured to:
stop the received change of the position of the boundary in a case where the image that is not disposed in the area before the change of the position of the boundary is disposed in the area after the change of the position of the boundary with the change of the range of the area due to the change of the position of the boundary, and in a case where the disclosure range corresponding to the area is beyond the disclosable range set in advance for the data corresponding to the image.

19. The information processing apparatus according to claim 18, wherein the processor is configured to:
further receive an input regarding permission or prohibition of change of the disclosable range set in advance for the data with the change of the position of the boundary; and
cancel the stop to reflect the change of the position of the boundary in a case where the input indicating the permission is received.

20. A non-transitory computer readable medium storing an information processing program that causes a computer to execute processing of
displaying an area divided by disclosure range of data on a screen,
executing at least one of processing of displaying the area in a different display mode by disclosure range or processing of changing a display mode of an image representing the data depending on a display position of the image on the screen, and
in a case where the image is disposed in the area, disclosing the data corresponding to the image to a disclosure destination included in the disclosure range corresponding to the area.
